(19) United States
(12) Patent Application Publication
(10) Pub. No.: US 2026/0228993 A1
(43) Pub. Date: Aug. 6, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TAKU OGASAWARA, Tokyo (JP)

(21) Appl. No.: 19/450,552

(22) Filed: Jan. 15, 2026

(30) Foreign Application Priority Data
Feb. 4, 2025 (JP) 2025-016869

(51) Int. Cl. G06T 19/20; G06T 19/00

(52) U.S. Cl. CPC G06T 19/20; G06T 19/00; G06T 2200/24; G06T 2219/2012

(57) ABSTRACT

An image processing apparatus acquires, based on a mock-up, first information for identifying a three-dimensional (3D) model corresponding to the mock-up and performs control of displaying an edit screen on which second information for generating a mock-up based on the 3D model is editable.

### BACKGROUND

### Field of the Technology

The technique of the present disclosure relates to a technique of generating a mock-up using a three-dimensional (3D) model.

### Description of the Related Art

There has been a technique of generating a mock-up of an object using a 3D model of the object that was generated using volumetric capture or the like. Japanese Patent Laid-Open No. 2022-131777describes a method of determining a 3D model of an object, of which a figure is to be generated, by operating a virtual camera while viewing virtual viewpoint images generated using a plurality of 3D models generated by the volumetric capture, and then generating formative data for generating a figure based on the determined3D model.

In the prior art, a 3D model to be used in generating a mock-up is determined by operating a virtual camera. In recent years, there has been a demand for determining a 3D model to be used in generating a mock-up, by using various methods.

### SUMMARY

Embodiments of the present disclosure are directed to providing a method that can easily determine a 3D model to be used in generating a mock-up.

According to an aspect of the present disclosure, an information processing apparatus includes one or more memories storing instructions and one or more processors. The one or more processors execute the instructions to acquire, based on a mock-up, first information for identifying a three-dimensional (3D) model corresponding to the mock-up and to perform control of displaying an edit screen on which second information for generating a mock-up based on the 3D model is editable.

Features of various embodiments will become apparent from the following description of embodiments with reference to the attached drawings. The following description of embodiments is described by way of example.

### BRIEF DESCRIPTION OF THE DRAWINGS

FIGS. 1A to 1C are diagrams illustrating a system according to the first embodiment.

FIGS. 2A to 2F are diagrams illustrating a database configuration according to the first embodiment.

FIGS. 3A to 3D are diagrams illustrating a virtual camera according to the first embodiment.

FIGS. 4A to 4E are diagrams illustrating generation of information according to the first embodiment.

FIGS. 5A and 5B are block diagrams illustrating a configuration of an image processing apparatus according to the first embodiment.

FIG. 6 is a flowchart illustrating processing in which the image processing apparatus according to the first embodiment generates formative data.

FIGS. 7A to 7C are diagrams illustrating a display screen controlled to be displayed by the image processing apparatus according to the first embodiment.

FIGS. 8A and 8B are diagrams illustrating a formative data setting change screen to be displayed by the image processing apparatus according to the first embodiment.

FIGS. 9A and 9B are diagrams illustrating a display screen controlled to be displayed by an image processing apparatus according to a third embodiment.

### DESCRIPTION OF THE EMBODIMENTS

Hereinafter, embodiments of the present disclosure will be described with reference to the drawings. The components to be described in the following embodiments indicate an example of the embodiment, and are not intended to limit every embodiment to these.

### Embodiment

According to an embodiment of the present disclosure, an information processing apparatus includes an acquisition unit configured to acquire, based on a mock-up, first information for identifying a three-dimensional (3D) model corresponding to the mock-up. The information processing apparatus includes a display control unit configured to perform control of displaying an edit screen on which second information for generating the mock-up based on the 3D model is editable.

The mock-up is, for example, a figure, an acrylic stand, or a keyholder.

The first information is generation information used to generate the mock-up, for example. Specifically, the first information includes an identifier representing an object corresponding to the 3D model, a timecode (time information) corresponding to the 3D model, a size of the mock-up, an identifier representing the 3D model, and a name of a scene corresponding to the 3D model. The first information may also include a scale size (magnification ratio) to be used in generating the mock-up from the 3D model. The first information may also include color information. The first information may also include a support member to be used to generate a mock-up. The support member is, for example, a transparent material surrounding a region in a figure that corresponds to a subject, a coupling member for coupling regions of the subject, a supporting column for supporting a member corresponding to the subject, and the like. The first information may also include the type of the mock-up.

In a case where the type of the mock-up is an acrylic stand, the first information includes information representing the position and orientation of a virtual camera that is to be used in generating a virtual viewpoint image included in an acrylic stand. In a case where the type of the mock-up is a keyholder, the first information includes information representing the shape and the material of the coupling member. The coupling member refers to, for example, a chain, a hook, or a band.

The second information is formative data to be used to generate a mock-up, for example. Specifically, like the first information, the second information is also generation information. The second information is generation information, but the second information may be generation information of a 3D model different from that of the first information.

With this configuration, a user can generate a new figure based on a 3D model corresponding to an already-generated figure, from the figure. For example, formative data for generating a figure desired by the user can be generated with reference to a figure exhibited in a store. Also, a figure at different orientation that represents the same subject can be generated, based on a figure owned by the user.

The acquisition unit may also acquire the first information based on a captured image including the mock-up. Specifically, the acquisition unit acquires the first information by identifying a marker added to a figure included in a captured image. Also, the acquisition unit may acquire the first information by identifying the shape of a figure included in a captured image.

The acquisition unit may also acquire the first information based on communication with a communication unit associated with the mock-up. Specifically, the acquisition unit may acquire the first information by utilizing a tag attached to a figure, and near field communication (NFC). The first information may also be recorded in a recording medium added to a figure, and the first information may also be acquired via the communication unit. Also, an address of the first information recorded in an external server may be recorded in a recording unit added to a figure, the address may be acquired via a communication unit, and the first information may be acquired from the external server using the address.

The information processing apparatus also includes a generation unit that generates the edit screen.

The 3D model may also be generated based on a plurality of captured images. Specifically, the 3D model may be generated using volumetric capture, or the 3D model may be generated using photogrammetry.

According to another example embodiment, an image processing system includes a first acquisition unit that acquires, based on a mock-up, first information for identifying a 3D model corresponding to the mock-up. The image processing system also includes a second acquisition unit that acquires the 3D model based on the first information. The image processing system also includes a generation unit that generates an edit screen on which second information for generating a mock-up based on the3D model is editable. The image processing system also includes a display control unit that performs control of displaying the edit screen.

According to another example embodiment, an information processing method includes an acquisition step of acquiring, based on a mock-up, first information for identifying a 3D model corresponding to the mock-up. The information processing method also includes a display control step of performing control of displaying an edit screen on which second information for generating a mock-up based on the 3D model is editable.

### Embodiments

Hereinafter, example embodiments of the present disclosure will be described with reference to the drawings. The example embodiments to be described indicate an example of a case where the present disclosure is specifically carried out, and some embodiments are not limited thereto.

### First Embodiment

In the present embodiment, an image of a figure generated using a3D model of a subject that has been generated by the volumetric capture is captured by a user device, such as a smartphone. A configuration will then be described of displaying a composite image including a different 3D model of the same subject as a figure on a user device, and of generating formative data for generating a new figure by the user selecting the 3D model.

In the present embodiment, a preliminarily generated figure will also be referred to as a first output material, and a figure generated based on new formative data generated based on a user operation will also be referred to as a second output material.

### Volumetric Capture System, and Overall Configuration of System Including the Same

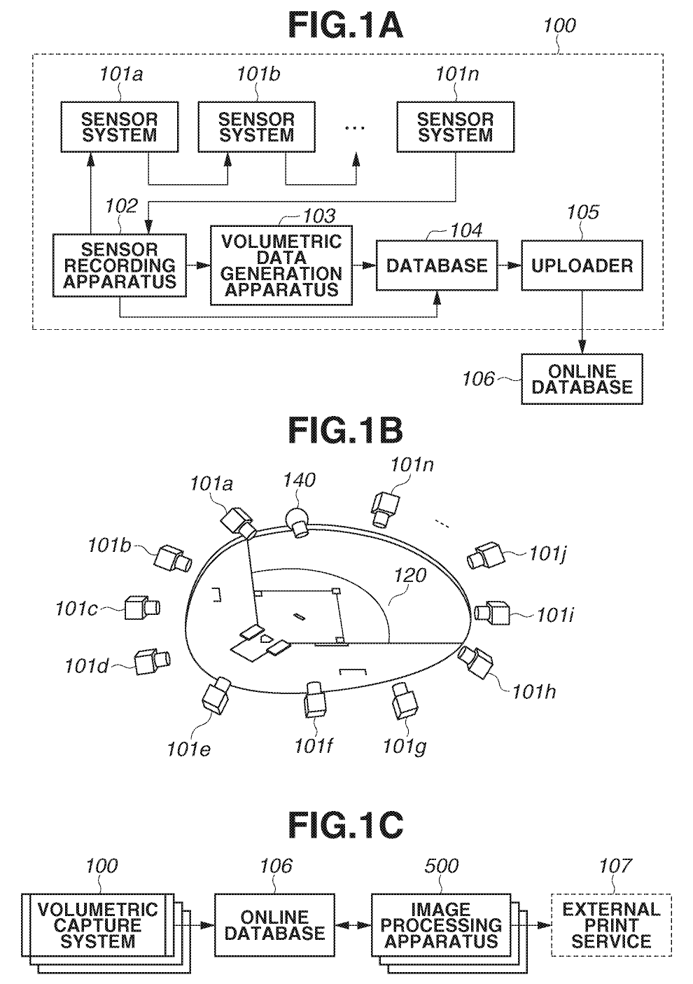

FIGS. 1A to 1C are diagrams illustrating the overall system according to the present embodiment.

FIG. 1A illustrates a system configuration diagram of a volumetric capture system 100.

The volumetric capture system 100 includes n sensor systems (sensor systems 101a to 101n). The volumetric capture system 100 also includes a sensor recording apparatus 102, a volumetric data generation apparatus 103, a database 104, and an uploader 105. Each sensor system includes, as at least one imaging apparatus, a visible light camera (RGB camera, hereinafter, also simply referred to as a camera).

Hereinafter, unless otherwise stated, the n sensor systems will be described as a plurality of sensor systems 101 without discriminating between sensor systems.

FIG. 1B is a diagram illustrating an installation example of the plurality of sensor systems 101. The plurality of sensor systems 101 are installed in such a manner as to surround an image capturing region 120, which is a target region of image capturing, and capture images of the image capturing region 120 from different directions. Examples of the image capturing region 120 serving as an image capturing target include a field or the like of a stadium or a dome where sport matches are held, and n (e.g., 100) sensor systems 101 are installed in such a manner as to surround the field. The number of a plurality of sensor systems 101 to be installed is not limited. The image capturing region 120 serving as an image capturing target is not limited to a field of a stadium or a dome. For example, the image capturing region 120 may include spectators' seats or the like of the dome, a stage of an arena, a stage set, or the like.

A subject to be image-captured by the volumetric capture system 100 is an object or a person existing on the image capturing region 120. The number of objects or persons serving as image capturing targets is not limited, and all objects and persons included in the image capturing region 120 are targeted.

The plurality of sensor systems 101 need not be installed over the entire circumference of the image capturing region 120 either, and may be installed only in a part of the circumference of the image capturing region 120 due to restrictions on an installation location or the like. A plurality of cameras included in the plurality of sensor systems 101 may also include imaging apparatuses having different functions, such as a telephoto camera and a wide angle camera.

The cameras in the plurality of sensor systems 101 synchronously perform image capturing. To perform synchronous image capturing, a timecode is used as an image capturing time.

The timecode is information for uniquely identifying an image capturing time in the volumetric capture system 100, and the timecode is designated in a format such as "day:time:minute:second.frame number".

The timecode can be rephrased as time information. In the example of the present embodiment, an image capturing rate of the volumetric capture system 100 is set to 59.94 frames per second (FPS), but the image capturing rate is not limited to this value. The timecode in image capturing is also used for the management of volumetric data to be described below.

The plurality of sensor systems 101 may include microphones (not illustrated) in addition to the cameras. Each microphone of the plurality of the sensor systems 101 synchronously collects voice. Based on the collected voice, an acoustic signal to be reproduced together with the display of a virtual viewpoint image to be described below can be generated. Hereinafter, for the sake of simplification of explanation, the description on acoustics will sometimes be omitted, but images and acoustic data are basically processed together.

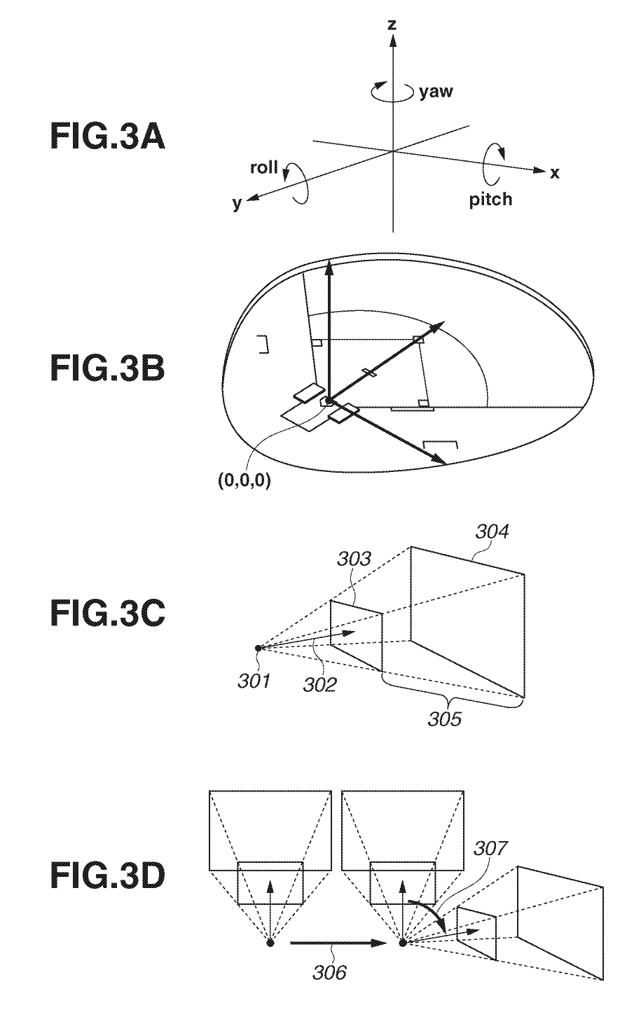

A virtual camera 140 is arranged in a virtual space associated with the image capturing region 120. The position and orientation of the virtual camera 140 is operated in the virtual space, and the virtual camera 140 can view the image capturing region 120 from a viewpoint different from all of the plurality of sensor systems 101, without being constrained by physical limitations. The virtual camera 140 will be described below with reference to FIGS. 3A to 3D.

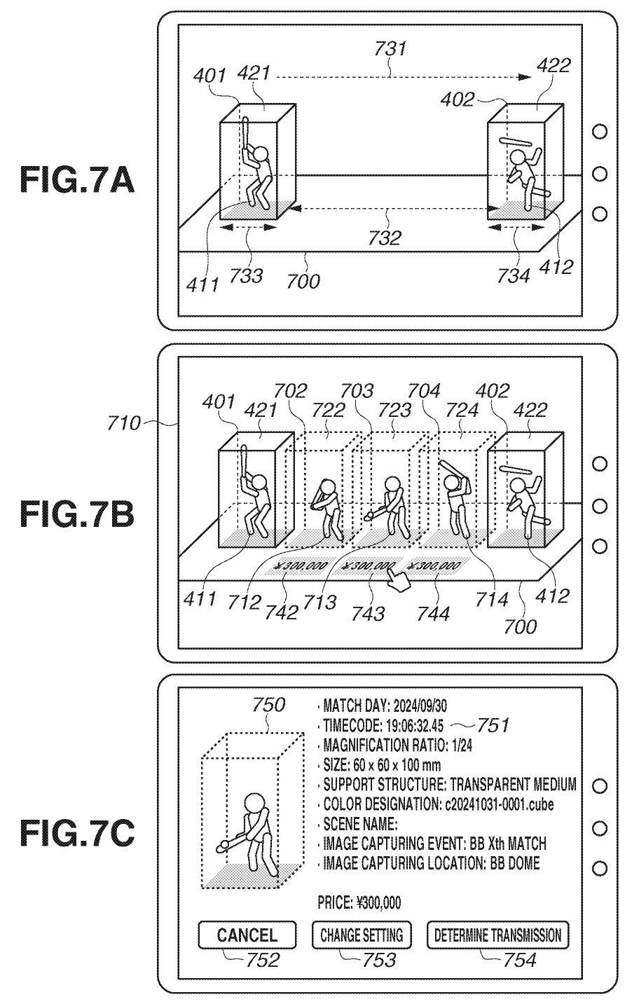

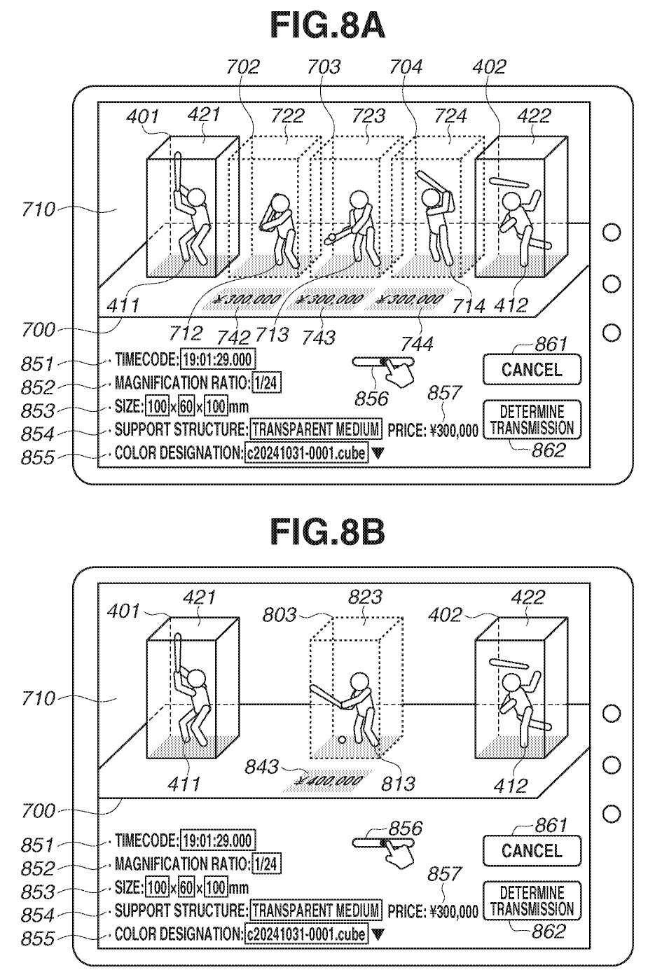

An image captured by the virtual camera 140 will be referred to as a virtual viewpoint image. The virtual viewpoint image may be generated in such a manner as to include only an object or a person existing in the image capturing region 120. In this case, it is sufficient that a field and spectators' seats that exist in the background are hidden, and such a viewing method is used in augmented reality (AR) or the like. In the present embodiment, the AR is mainly used for the display of the virtual viewpoint image, and a display example thereof will be described below with reference to FIGS. 7A to 7C, 8A, and 8B. The virtual viewpoint image to be displayed in the present embodiment is not limited to an AR image, and may be a normal two-dimensional (2D) image.

The sensor recording apparatus 102 acquires a plurality of captured images and acoustic data from the plurality of sensor systems 101, and the sensor recording apparatus 102 stores the captured images and the acoustic data into the database 104 together with a timecode used in image capturing.

The volumetric data generation apparatus 103 acquires, from the database 104, the plurality of captured images acquired from the plurality of sensor systems 101, and the volumetric data generation apparatus 103 generates volumetric data of persons or the like that are included in the captured images. Based on the volumetric data, a 3D model (also referred to as a three-dimensional model) and acoustic data of a subject can be generated. The 3D model includes three-dimensional shape data representing a three-dimensional shape and includes color information. The volumetric data may further include a bounding box surrounding the 3D model. The bounding box may be a bounding rectangle of the 3D model, or the bounding box may be a region provided in at least a predetermined distance from the 3D model.

As a specific 3D model generation method, a foreground image obtained by extracting a foreground region including a person or an object, such as a ball, and a background image obtained by extracting a background region other than the foreground region are acquired from a plurality of captured images. Based on a plurality of obtained foreground images, a 3D model representing a three-dimensional shape of a foreground can be generated for each object. Such a 3D model is generated by using a shape estimation method, such as the visual hull, for example, and includes a point group and the like. The 3D model generation method is not limited to this. In addition, a 3D model data format of each object is not limited to a point group, and a 3D model may be a mesh or the like.

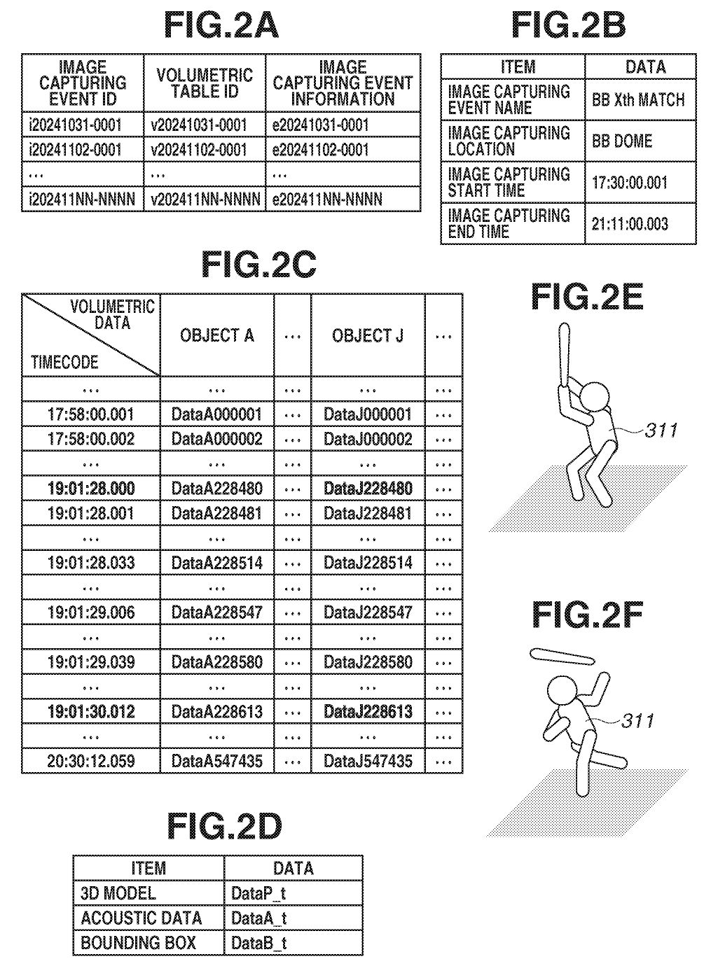

The volumetric data generation apparatus 103 stores the generated 3D model and the acoustic data into the database 104 as volumetric data. A configuration of the database 104 storing such data will be described below with reference to FIGS. 2A to 2F.

The uploader 105 uploads the entire table including volumetric data, from the database 104 to an online database 106. Each time volumetric data is written into the database 104, the uploader 105 may read out the volumetric data for each timecode unit and upload the volumetric data to the online database 106.

The overview of the overall system according to the present embodiment will be described with reference to FIG. 1C. The present system includes the volumetric capture system 100, the online database 106, an external print service 107, and image processing apparatuses 500. The present system may also include a plurality of volumetric capture systems 100. For example, the present system may also include a plurality of volumetric capture systems 100 for capturing images of different domes, stadiums, arenas, or the like.

An event in which the volumetric capture system 100 captures images will be referred to as an image capturing event. The image capturing event may be an event of a match of a professional sport or a live event of an artist.

The image capturing event is performed as a different event for each match or each live event, and the image capturing event is identified based on an image capturing event ID. An image capturing event ID is uniquely allocated without duplication even in a plurality of volumetric systems.

The online database 106 receives the upload of volumetric data from a plurality of volumetric capture systems 100 together with an image capturing event ID, and the online database 106 accumulates and manages volumetric data for each image capturing event. The configurations of a database and a table for managing such data will be described below with reference to FIGS. 2A to 2F.

The image processing apparatus 500 is a user terminal, such as a smartphone or a tablet, that includes a camera and various sensors. The image processing apparatus 500 displays a composite image generated by using captured images acquired by capturing images of a preliminarily generated figure, on a display unit such as a display. The preliminarily generated figure is a first output material. The composite image also includes the preliminarily generated figure and a 3D model of the same subject as the figure that corresponds to a different timecode.

A 3D model including color information needs not be always displayed, and three-dimensional shape data of a subject to which single color information is allocated may be displayed. The image processing apparatus 500 acquires information regarding the preliminarily generated figure and arrangement information of the figure from a captured image. These pieces of information will be described below.

Based on the arrangement information, generation information, and the like, the image processing apparatus 500 also connects to the online database 106 and acquires volumetric data corresponding to a different timecode of the preliminarily generated figure. A plurality of pieces of formative data are then generated based on the acquired volumetric data, and a composite image in which a virtual viewpoint image generated from the formative data is arranged next to the preliminarily generated figure is displayed. The details of the composite image will be described with reference to FIGS. 7A to 7C. The image processing apparatus 500 also receives an instruction to select a generation target of a figure, which is a second output material, by using the displayed composite image, and the image processing apparatus 500 outputs the selected formative data to the external print service 107 or the like. The formative data includes three-dimensional shape data representing a three-dimensional shape of a subject, color information, a support structure, and the like. At the time of figure generation, color information included in a 3D model of a subject may also be converted. In a case where color information is converted, information obtained when color information is converted is included in an item of color setting included in formative data.

In the present embodiment, an example in which the image processing apparatus 500 generates a composite image and displays the composite image will be described, but some examples are not limited thereto. For example, the image processing apparatus 500 may also display the composite image by an image generation server (not illustrated) generating a composite image and outputting the composite image to the image processing apparatus 500. In this case, the image processing apparatus 500 outputs information regarding the preliminarily generated figure, and the arrangement information, to the image generation server. The image generation server acquires volumetric data corresponding to a timecode different from that of the preliminarily generated figure, based on such pieces of information. As illustrated in FIG. 1C, a plurality of image processing apparatuses 500 may also be included, and each image processing apparatus 500 can generate formative data by independently acquiring volumetric data from the online database 106.

### Database Configuration of Volumetric Data

A table configuration for managing volumetric data in the online database 106, and volumetric data will be described with reference to FIGS. 2A to 2F.

In a database storing volumetric data, a table for managing volumetric data is separated for each image capturing event. Each image capturing event and each table has identifiers, which will be referred to as an image capturing event ID and a volumetric table ID, respectively.

FIG. 2A illustrates a database for managing correspondence between an image capturing event ID and a volumetric table ID, and the database will be referred to as an image capturing event management database. The database stores an image capturing event ID, a volumetric table ID, image capturing event information, and the like.

The image capturing event ID is information for uniquely identifying an image capturing event, and, for example, an identifier, such as "i20241031-0001", is stored. An image capturing event ID is a uniquely identifiable ID even in a case where a plurality of volumetric capture systems 100 is included.

The volumetric table ID is an identifier of a table for managing volumetric data, and desired volumetric data can be accessed when the identifier is designated. For example, an identifier, such as "v20241031-0001", is stored.

As the image capturing event information, an identifier of image capturing event information is stored, and a desired image capturing event can be accessed when the identifier is designated. For example, an identifier, such as "e20241031-0001", is stored.

FIG. 2B illustrates image capturing event information. As illustrated in FIG. 2B, an image capturing event name, an image capturing location, an image capturing start time, an image capturing end time, and the like are stored in the image capturing event information. Each item will now be described.

As the image capturing event name, an event name itself or the like is stored. For example, as illustrated in FIG. 2B, "BB Xth match" or the like is stored. The image capturing event name may also be manually set.

As the image capturing location, a location where an image capturing event was held is stored. For example, as illustrated in FIG. 2B, "BB dome" or the like is stored. The image capturing location may also be manually set.

As the image capturing start time and the image capturing end time, timecodes of start and end times of an image capturing event are stored. For example, as illustrated in FIG. 2B, "17:30:00.001" and "21:11:00.003" are stored. The image capturing start time and the image capturing end time may also be reflected from a timecode representing a time at which the volumetric capture system 100 starts to store volumetric data into a table and from a timecode representing a time at which the volumetric capture system 100 ends storing. Also, the image capturing start time and the image capturing end time may be manually set.

The image capturing event information is not limited thereto and may include another type of information as long as the information is information regarding an image capturing event.

As illustrated in FIGS. 2A and 2B described above, designating an image capturing event ID makes it possible to refer to a volumetric table ID and image capturing event information that correspond to the image capturing event ID.

FIG. 2C illustrates a table storing volumetric data including a 3D model generated by the volumetric capture system 100, and the table will be referred to as a volumetric data table 200. As described above with reference to FIG. 2A, the volumetric data table 200 is identified based on a volumetric table ID.

The volumetric data table 200 is a table in which timecodes are stored along a vertical axis and volumetric data of each object is stored along a horizontal axis. That is, in the volumetric data table 200, volumetric data is stored for each timecode unit and for each object unit.

Timecodes along the vertical axis are stored for each frame. For example, a record is stored each time a frame number is counted up, in a format of a timecode "day:time:minute:second.frame number". The frame number needs not be counted up for each frame either. In the present embodiment, in a case where an image capturing frame rate of the volumetric capture system 100 is 59.94 FPS, for example, records are stored at an interval of about 16.667 milliseconds.

Objects along the horizontal axis are objects, persons, and the like that are included in the image capturing region 120. For example, if an image capturing event is a baseball match, each player or a ball serves as an object.

For example, as for an "object J" on a fifth row from the top of the volumetric data table 200 in FIG. 2C, volumetric data "DataJ228480" of the "object" J for a timecode "19:01:02.034" is stored.

In a similar manner, as for the "object J" on a third row from the bottom of the volumetric data table 200 in FIG. 2C, volumetric data "DataJ228613" of the "object" J for a timecode "19:01:30.012" is stored.

FIG. 2D illustrates a data configuration corresponding to one frame of volumetric data. As listed in FIG. 2D, volumetric data includes a 3D model, acoustic data, a bounding box, and the like.

The 3D model includes three-dimensional shape data indicating a three-dimensional shape of a subject and includes color information. For example, in a case where a 3D model is a point group, three-dimensional coordinates of all point groups of the 3D model are recorded as three-dimensional shape data. In the present embodiment, three-dimensional shape data and color information are collectively described as DataP_t. In the table example illustrated in FIG. 2C, a 3D model varying for each object is stored, but all objects may also be collectively handled as one 3D model.

The acoustic data is acoustic data of each object. A microphone or the like is prepared for each object and collects voice. In the table example illustrated in FIG. 2C, acoustic data varying for each object is stored, but a single piece of data obtained by collecting voice of the entire image capturing region 120 may be handled as the acoustic data.

The bounding box is a region surrounding the above-described 3D model. Specifically, in the present embodiment, the bounding box is a three-dimensional coordinate DataB_t representing a coordinate of each vertex of a bounding rectangle of the 3D model. For example, a value of the bounding box is to be used in a case where transparent material is applied as a support structure when a figure is generated. As the size of the transparent material, a value obtained by adding a margin with a predetermined width to the bounding box may also be set.

The volumetric data is not limited to the above-described data, and any information acquired through volumetric capture may also be included.

Next, an example of a 3D model included in volumetric data stored in the volumetric data table 200 will now be described with reference to FIGS. 2E and 2F. FIGS. 2E and 2F are diagrams illustrating 3D models corresponding to different timecodes included in the same scene. The scene in the present embodiment corresponds to a specific time. For example, the scene is a time corresponding to one play time in baseball. As a specific example, the scene corresponds to a time during which a batter hits a ball or also to a time from a timecode indicating a time at which a pitcher starts pitching to a timecode indicating a time at which a fielder makes a catch. FIGS. 2E and 2F correspond to a scene in which a batter hits a ball.

The data of the scene illustrated in FIG. 2E is stored in the volumetric data table 200 as volumetric data "DataJ228480" of the "object J" at a timecode "19:01:28.000". As illustrated in the example in FIG. 2E, the timecode corresponds to a timecode representing a time at which a batter 311 waits for the pitcher's pitching and starts swinging.

The data of the scene illustrated in FIG. 2F is stored in the volumetric data table 200 as volumetric data "DataJ228613" of the "object J" at a timecode "19:01:30.012". As illustrated in the example in FIG. 2F, the timecode corresponds to a timecode representing a time after the batter 311 swings at a pitch of a pitcher.

As illustrated in FIGS. 2E and 2F, in a case where volumetric capture is used, shapes, positional relationship, and the like in a real space can be reflected as-is in all point groups of the 3D model.

In other words, although it is difficult to see in the example illustrated in FIGS. 2E and 2F, volumetric data is generated in an actual dimension, and if a player is 180 cm, volumetric data is also generated in the same size.

With the above-described configuration, by designating an arbitrary image capturing event ID (or table ID), a timecode, and an object ID, it becomes possible to acquire volumetric data including a unique 3D model image-captured at a time corresponding to a certain timecode of the event.

### Virtual Camera

The virtual camera 140 will be described with reference to FIGS. 3A to 3D. The virtual camera 140 is designated using one coordinate system. As the coordinate system, a typical three-dimensional orthogonal coordinate system including X, Y, and Z axes illustrated in FIG. 3A is used. As a unit of the coordinate system, for example, the meter is used.

The coordinate system is set in an image capturing target and used. Examples of the image capturing target include a field or the like of a stadium or a dome, as illustrated in FIG. 1B. As illustrated in FIG. 3B, the image capturing target includes the entire image capturing region 120 and also includes a player, an object, and the like that exist in the image capturing region 120. A subject may include spectators' seats or the like around the field.

In the setting of the coordinate system in the image capturing target, any point in the field (image capturing region) 120 is set as an origin (0, 0, 0). For example, in a case where the image capturing region 120 is a field of baseball, a home base may be set as an origin.

In addition, the X-axis is set to a second base direction in the image capturing region 120, the Y-axis is set to a direction from a third base to a first base of the image capturing region 120, and the Z-axis is set to a vertical direction with respect to a field surface. The setting of the coordinate system is not limited to these.

Next, a virtual camera will be described with reference to FIGS. 3C and 3D. A virtual camera (or a virtual viewpoint) serves as a viewpoint for drawing a virtual viewpoint image.

In a square pyramid illustrated in FIG. 3C, a vertex indicates a position 301 of the virtual camera, and a vector extending from the vertex indicates an orientation 302 of the virtual camera. The position 301 of the virtual camera is represented by a coordinate (x, y, z) in a three-dimensional space, and the orientation 302 is represented by a unit vector having components of axes as scalar.

The orientation 302 of the virtual camera passes through central points of a front clip surface 303 and a back clip surface 304. In addition, a space 305 sandwiched by the front clip surface 303 and the back clip surface 304 is referred to as a frustum of the virtual camera and corresponds to a range in which a virtual viewpoint image is generated (also, range in which a virtual viewpoint image is projected and displayed; hereinafter, referred to as a display region of a virtual viewpoint image). The orientation 302 of the virtual camera is represented by a vector and is also referred to as an optical axis vector of the virtual camera.

The movement and rotation of the virtual camera will be described with reference to FIG. 3D. The virtual camera moves and rotates within a space represented by a three-dimensional coordinate.

A movement 306 of the virtual camera is the movement of the position 301 of the virtual camera, and the movement 306 is represented by axis components (x, y, z). A rotation 307 of the virtual camera is represented by Yaw, which is rotation around the Z-axis; pitch, which is rotation around the X-axis; or roll, which is rotation around the Y-axis, as illustrated in FIG. 3A.

As described above, by designating X, Y, Z coordinates (x, y, z) of the virtual camera and rotational angles (pitch, roll, yaw) of the X, Y, and Z axes, it is possible to operate the position and the orientation of the virtual camera to arbitrary values.

With this configuration, the virtual camera can freely move and rotate within a three-dimensional virtual space in which a 3D model generated from a subject is to be arranged, and the virtual camera can generate an image of an arbitrary region in the virtual space as a virtual viewpoint image.

In the present embodiment, the image processing apparatus 500 to be described below is a smartphone or a tablet, includes a camera and various sensors, and can perform AR display. AR is a general technique, and the detailed description of AR will be omitted. The image processing apparatus 500 can calculate the position and the orientation of the image processing apparatus 500 in a world coordinate set in a real world by using the camera and the various sensors. By setting the calculated position and orientation of the image processing apparatus 500 as the position and orientation of the virtual camera, it is possible to easily perform AR display.

Information regarding the position and the orientation of the virtual camera will be hereinafter referred to as virtual camera information. Information included in virtual camera information may include a focal length and the like as well as the position and the orientation.

### Figure and Generation Information

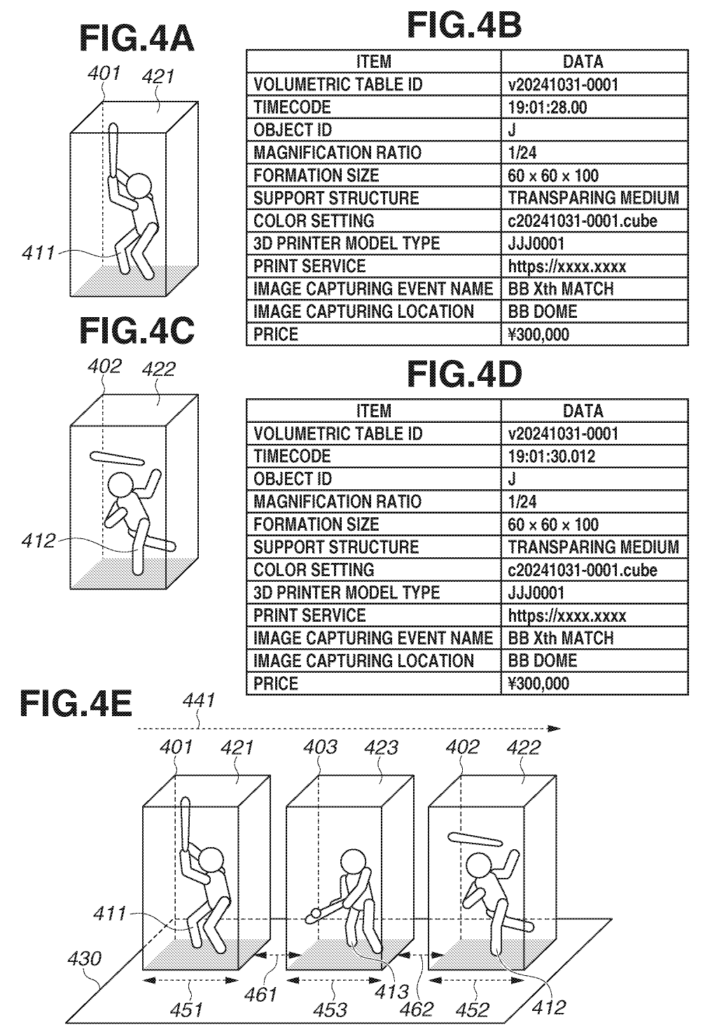

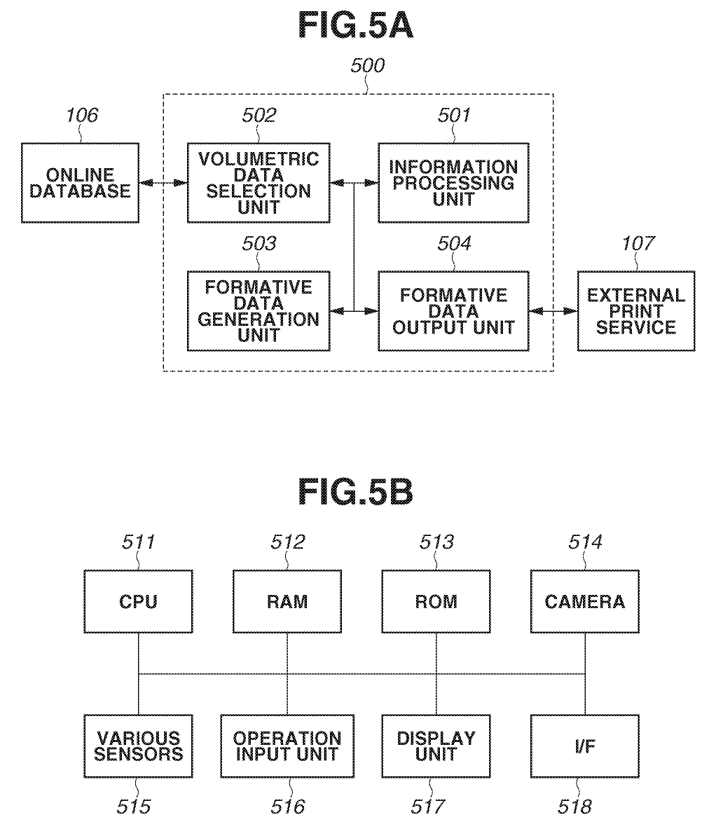

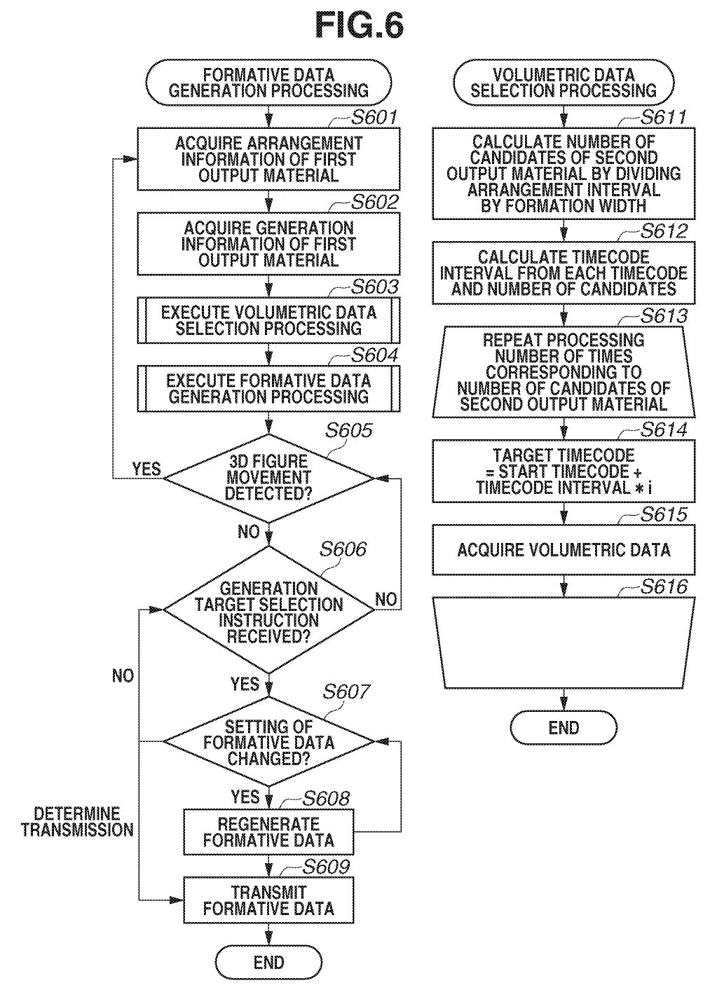

To describe formative data generation processing (FIG. 6), which is a characteristic of the present embodiment, and an image processing apparatus (FIGS. 5A and 5B) that executes the formative data generation processing, a generated figure, which is a first output material that serves as a prerequisite of the processing, and generation information added to the generated figure, will be described with reference to FIGS. 4A to 4E.

A figure serving as the first output material that has been generated by a 3D printer will be described with reference to FIGS. 4A and 4C. FIGS. 4A and 4C illustrate an example of a figure generated in the external print service 107 (or a 3D printer (not illustrated)) by using formative data generated based on volumetric data in FIGS. 2E and 2F.

In FIGS. 4A and 4C, FIGS. 401 and 402 respectively include player portions (foreground portions) 411 and 412 generated based on a 3D model included in volumetric data and include transparent material portions 421 and 422 that are not included in the volumetric data.

The transparent material portions 421 and 422 serve as one type of a support structure for figures, are transparent materials for covering the main bodies that are generally used in figures, and are generated by the 3D printer simultaneously with the player portions 411 and 412 of the main bodies. The support structure is not limited to this, and the support structure of the figure includes a supporting column, a coupling member, and the like that couple members, such as a 3D model and a seat.

Generation information added to the figure serving as a first output material will be described with reference to FIGS. 4B and 4D.

In the generation information, information to be used in the generation of formative data based on which a figure has been generated and information to be used when the figure is generated by the external print service 107 or the like are stored. Specifically, the generation information includes a volumetric table ID, a timecode, an object ID, a magnification ratio, a generation size, a support structure, a color setting, a 3D printer model, a print service, an image capturing event name, an image capturing location, a price, and the like.

The items of the generation information are common between the first output material and the second output material. That is, the generation information is information regarding a figure of a first output material and is information to be used when a figure of a second output material chronologically related to this is generated. In other words, the items of the generation information are used also as items of formative data.

The generation information can be acquired from the first output material using a general technique. For example, the generation information may be acquired from a quick response (QR) code®, an AR marker, or the like. In addition, the generation information may also be acquired via the NFC, Bluetooth Low Energy (BLE), or the like.

FIGS. 4B and 4D illustrate examples of generation information added to the FIGS. 401 and 402 of the first output material in FIGS. 4A and 4C.

As described above with reference to FIGS. 2E and 2F, the FIGS. 401 and 402 correspond to a start timecode and an end timecode of one swing of the same batter in the same match and included in the same scene.

For this reason, in the generation information to be described below, image capturing event names, volumetric table IDs, and the like remain the same values. In the following description, an item including different values will be indicated as such, and the same values are stored in other cases.

As a volumetric table ID, a unique table ID of a table storing volumetric data in the online database 106 is stored. For example, in FIGS. 4B and 4D, a volumetric table ID "v20241031-0001" of a table storing volumetric data based on which the figures in FIGS. 4A and 4C are generated is stored.

As a timecode, a timecode of volumetric data based on which a corresponding figure is generated is stored. For example, in FIGS. 4B and 4D, as described above with reference to FIGS. 2E and 2F, timecodes "19:01:28.000" and "19:01:30.012" of volumetric data based on which the FIGS. 401 and 402 are generated are stored.

As an object ID, an identifier of a person or an object existing in the image capturing region 120 is stored.

As described above with reference to FIGS. 2E and 2F, in the examples illustrated in FIGS. 4B and 4D, an object ID "J" is stored.

As a magnification ratio, a magnification ratio with respect to volumetric data based on which a corresponding figure is generated is stored. As described above with reference to FIGS. 2E and 2F, since volumetric data is generated in an actual dimension, when the volumetric data is generated as a figure, a magnification ratio such as 1/8, 1/16, 1/24, or 1/32 is used. The value of the magnification ratio is not limited and is only required to be a numerical value, and the value of the magnification ratio may be the same size, a double, or the like. In the example illustrated in FIGS. 4B and 4D,1/24 is stored.

A generation size is a generation size of a corresponding figure, and a width, a depth, and a height are stored.

Not a value designating the magnification ratio of volumetric data, but a final generation size including a support structure and the like is stored. In the example illustrated in FIGS. 4B and 4D, a width of 60 mm, a depth of 60 mm, and a height of 100 mm, which correspond to a generation size of the FIGS. 401 and 402, are stored.

A support structure is a portion in a figure that is other than volumetric data (foreground), and for example, a transparent material, a supporting column, or the like is set. In the example illustrated in FIGS. 4B and 4D, a transparent material (the transparent material portion 421 or 422), which is a support structure added when the FIG. 401 or 402 is generated, is stored.

As a color setting, a color setting made when formative data is generated is stored. For example, an identifier, such as a file name or the like of a 3D LUT, may be stored. In the example illustrated in FIGS. 4B and 4D, "c20241031-0001.cube" is stored as an identifier of a 3D LUT. When volumetric data is generated by a3D printer, the volumetric data globally becomes darker than a case where a video or the like is displayed on a display, and thus a 3D LUT for figures is sometimes prepared for each image capturing event, and the 3D LUT for figures may be stored. The 3D LUT need not be used as a color setting. Setting values of brightness, saturation, and contrast may be stored, and these may also be used as a color setting.

As a 3D printer model, a model type name of a3D printer that has generated a corresponding figure is stored. In the example illustrated in FIGS. 4B and 4D, "JJJ0001" is stored. Because the material and color tone of the 3D printer vary depending on the manufacturer, in a case where time-series figures are to be generated, the 3D printer of the same 3D printer model, or a successor device of the 3D printer, is desirably used, and this item is used for this.

A print service is an output uniform resource locator (URL) or the like of an external print service that has generated a corresponding figure. In the example illustrated in FIGS. 4B and 4D, "http://xxxx.xxxx" is stored.

In an image capturing event name, a value stored in image capturing event information associated with the volumetric data table ID is reflected. The image capturing event information is illustrated in FIG. 2B.

In the example illustrated in FIGS. 4B and 4D, "BB Xth match" corresponding to volumetric data table ID = "v20241031-0001" is stored.

In an image capturing location, a value stored in image capturing event information associated with the volumetric data table ID is reflected. The image capturing event information is illustrated in FIG. 2B. In the example illustrated in FIGS. 4B and 4D, "BB dome" corresponding to the volumetric data table ID = "v20241031-0001" is stored.

A price is a sales price of a figure. Generally, the sales price of a figure is often determined based on a generation size, and a predetermined margin is added thereto. A generation size may be transmitted to the external print service 107 or the like, and a price may be acquired as its response. In the example illustrated in FIGS. 4B and 4D, "300,000" is stored.

Heretofore, a figure serving as a first output material in the present embodiment and generation information to be added to the figure have been described. An output material in the present embodiment is not limited to the figure and is only required to be a product material generated from volumetric data, and an output material may be a product material with a plate shape.

### Time-Series Figure

Subsequently, a time-series figure in the present embodiment will be described with reference to FIG. 4E.

Time-series figures in the present embodiment refer to adjacently arranged figures corresponding to chronologically related timecodes in volumetric data image-captured and generated by the volumetric capture system 100.

In FIG. 4E, three FIGS. 401, 403, and 402 are arranged on a desk or a rack 430. The FIGS. 401 and 402 are the same figures as those illustrated in FIGS. 4B and 4D. The FIG. 403 arranged between the FIGS. 401 and 402 corresponds to a timecode "19:01:29.006", and the FIG. 403 is included between the two figures also from the aspect of timecode.

As described above, the FIGS. 401 and 402 correspond to a scene of a batter's swing in a baseball game, and the FIG. 403 also corresponds to a timecode indicating the moment at which a bat hits a ball in the same swing. An arrangement order of the FIGS. 401, 403, and 402 corresponds directly to the lapse order of timecodes.

In the present embodiment, the chronologically related state refers to a state of being included in a series of timecodes in an arbitrary one scene, as illustrated in FIG. 4E. The definition of start and end timecodes of one scene need not be strict, and it is sufficient that, in a case where figures are adjacently arranged, a viewer can subjectively recognize that the figures are included in the same scene.

In the present embodiment, for the sake of simplification of explanation, a case where time-series figures are arranged in one direction regarding the arrangement of time-series figures will be described. As described above, an arrangement order of the FIGS. 401, 403, and 402 corresponds directly to the lapse order of timecodes. At this time, an arrangement direction 441 is a direction in which figures are arranged along the lapse order of timecodes.

The time-series figures in the present embodiment have a figure width and an arrangement interval along the arrangement direction 441.

The figure width is a width set in a direction parallel to the arrangement direction 441 in a generation size of each figure, and the figure width represents a size of each figure. In the example illustrated in FIG. 4E, figure widths of the FIGS. 401, 403, and 402 are figure widths 451, 453, and 452, respectively. The figure width is often set to any one side of a generation size of a figure, but is not limited.

The arrangement interval is an interval between figures in a direction parallel to the arrangement direction 441 in the arrangement of figures. In the example illustrated in FIG. 4E, an arrangement interval between the FIGS. 401 and 403 is an arrangement interval 461, and an arrangement interval between the FIGS. 403 and 402 is an arrangement interval 462.

In the present embodiment, the above-described arrangement direction, the figure width, and the arrangement interval will be collectively referred to as arrangement information.

### Image Processing Apparatus

A configuration of the image processing apparatus 500 will now be described with reference to FIGS. 5A and 5B. FIG. 5A is a diagram illustrating a functional configuration example of the image processing apparatus 500. Functional configurations and processing overview of the image processing apparatus 500 will be described with reference to FIG. 5A, and the details of each piece of processing will be described below with reference to FIGS. 6 to 7C.

By acquiring various types of information from the FIGS. 401 and 402 of the first output material using functions illustrated in FIG. 5A, the image processing apparatus 500 selects volumetric data with a timecode chronologically related to these and generates formative data of the second output material from these.

Second output material candidate formative data is then displayed as a virtual viewpoint image adjacent to the FIGS. 401 and 402 of the first output material, and selection and output instructions are received. The details will be described below.

As illustrated in FIG. 5A, the image processing apparatus 500 includes an information processing unit 501, a volumetric data selection unit 502, a formative data generation unit 503, and a formative data output unit 504. Examples of the image processing apparatus 500 include a smartphone, a tablet, and the like, and software executing these functions will also be referred to as a client application or the like.

The information processing unit 501 acquires information from a figure group of the first output material and an arrangement environment by using a method of acquiring various types of information via hardware, such as a camera 514 and various sensors 515, which will be described below with reference to FIG. 5B. For example, the information processing unit 501 acquires arrangement information in the figure group and the arrangement environment via light detection and ranging (LiDAR) or infrared light. As described with reference to FIG. 4E, the arrangement information includes an arrangement direction, an arrangement interval, and a figure width. For example, the arrangement information may be acquired from a QR code, an AR marker, or the like that is included in a captured image. For example, information added to the FIGS. 401 and 402 may also be acquired via the NFC, the BLE, or the like. By using the above-described method of acquiring various types of information, the information processing unit 501 acquires image capturing data, arrangement information, generation information, and the like regarding the figure group and the arrangement environment.

The volumetric data selection unit 502 selects volumetric data with a timecode chronologically related to the FIGS. 401 and 402 from the arrangement information and the generation information acquired via the information processing unit 501. Volumetric data selection processing will be described below with reference to FIG. 6.

The formative data generation unit 503 generates formative data by using a 3D model selected and acquired by the volumetric data selection unit 502. The formative data may be information including the same items as those of the generation information. When formative data is generated, various setting values included in the generation information acquired by the information processing unit 501 are used. With this configuration, it is possible to generate formative data with the same information, such as size, color tone, and support structure, as those of a generated figure. The formative data includes, for example, a volumetric table ID, a timecode, an object ID, a magnification ratio, a generation size, a support structure, a color setting, a 3D printer model, a print service, an image capturing event name, an image capturing location, a scene name, a price, and the like. In place of a volumetric table ID and a timecode, a 3D model may also be included. Also, a 3D model may also be included together with a volumetric table ID and a timecode.

In addition, the formative data generation unit 503 generates a virtual viewpoint image from the generated formative data, and the formative data generation unit 503 generates a composite image in which the virtual viewpoint image is displayed adjacent to a figure serving as the first output material. As an example, a composite image is generated by superimposing a captured image, obtained by capturing an image of the figure serving as the first output material, and the virtual viewpoint image. The composite image is a so-called AR image.

The formative data output unit 504 receives a selection instruction and an output instruction of formative data displayed as a virtual viewpoint image via the formative data generation unit 503, and the formative data output unit 504 outputs the formative data to the external print service 107.

Next, a hardware configuration of the image processing apparatus 500 will be described with reference to FIG. 5B. The image processing apparatus 500 includes a central processing unit (CPU) 511, a random access memory (RAM) 512, a read-only memory (ROM) 513, the camera 514, various sensors 515, an operation input unit 516, a display unit 517, an interface (I/F) (external interface) 518.

The CPU 511 executes processing using programs and data stored in the RAM 512 and the ROM 513. The CPU 511 controls the operation of the image processing apparatus 500 and executes processing for implementing each function illustrated in FIG. 5A.

The ROM 513 stores programs and data. Examples of the programs and data include a client application or the like that is illustrated in FIG. 5A.

The RAM 512 includes a work area for temporarily storing programs and data read out from the ROM 513. The RAM 512 also provides a work area to be used when the CPU 511 executes each process.

The camera 514 is a camera, is a module obtained by combining a high-resolution sensor and a lens, and can capture an image and a moving image of an object existing near the image processing apparatus 500. For example, the camera 514 captures images of a generated figure group and the arrangement environment. The camera 514 may also capture images of a QR code and an AR marker attached thereto.

The various sensors 515 are not specifically limited, and the various sensors 515 measure a distance or the like regarding arrangement information in the figure group and the arrangement environment by using the LiDAR, infrared light, or the like, for example. For example, the various sensors 515 are sensors that perform proximity communication, such as the NFC or the BLE, and acquire various types of information added to the FIGS. 401 and 402.

The information processing unit 501 illustrated in FIG. 5A acquires image capturing data, arrangement information, and generation information of the FIGS. 401 and 402 by using the camera 514 and the various sensors 515.

The operation input unit 516 is, for example, a touch panel, and acquires information regarding an operation performed by the user.

For example, the operation input unit 516 receives a selection and an output instruction of formative data. The operation input unit 516 may connect with an external controller and may receive input information regarding an operation. The external controller is, for example, a three-axis controller, such as a joystick, a mouse, or the like. The external controller is not limited thereto.

The display unit 517 is a touch panel, a screen, or the like, and the display unit 517 displays a virtual viewpoint image of formative data and a setting change or the like of the formative data. In a case where the display unit 517 is a touch panel, the operation input unit 516 and the display unit 517 are integrally formed.

The I/F 518 is an external interface that performs transmission and reception of a network. The I/F 518 performs, via the internet or the like, data transmission and reception with the online database 106, the external print service 107, and the like, which are external systems.

### Formative Data Generation Processing

Formative data generation processing, which is a characteristic of the present embodiment, will be described with reference to FIGS. 6 to 7C.

FIG. 6 is a flowchart illustrating processing of generating formative data according to the present embodiment. The processing is executed by the image processing apparatus 500.

In step S601, the formative data generation unit 503 acquires, via the information processing unit 501, a captured image, information representing the position and orientation of the image processing apparatus 500, and arrangement information of a figure serving as the first output material. Specifically, the formative data generation unit 503 acquires the arrangement information via the information processing unit 501 from a captured image acquired by the image processing apparatus 500 capturing an image of the figure. The acquisition method is not limited to the above-described method, and the arrangement information may also be acquired using the LiDAR or the like.

FIGS. 7A to 7C are diagrams each illustrating a display example of formative data according to the present embodiment.

FIG. 7A illustrates an example in which a captured image—obtained by the image processing apparatus 500, such as a smartphone or a tablet terminal, capturing an image of the FIGS. 401 and 402 arranged on a desk 700—is displayed on the display unit 517. The information processing unit 501 acquires an arrangement direction 731, an arrangement interval 732, a figure width 733, and a figure width 734 by using the captured image. Here, as an example, it is assumed that the arrangement interval 732 = 200 mm, the figure width 733 = 60 mm, and the figure width 734 = 60 mm are acquired. The direction of the arrangement direction 731, and values of the arrangement interval 732, the figure width 733, and the figure width 734, may also be displayed on a display screen of an image display generation apparatus.

In step S602, the formative data generation unit 503 acquires, via the information processing unit 501, generation information of the figure serving as the first output material. In a case where a plurality of figures serving as the first output material exists, the formative data generation unit 503 individually acquires generation information corresponding to each figure.

As illustrated in FIG. 5A and 5B, the information processing unit 501 may also acquire generation information added to the figure, via the various sensors 515 supporting the NFC, the BLE, or the like. Generation information may also be acquired by capturing an image of a QR code (not illustrated) attached to a figure, by using the camera 514. In the example illustrated in FIGS. 7A to 7C, generation information of the FIG. 401 and generation information of the FIG. 402 are individually acquired.

In step S603, the volumetric data selection unit 502 performs selection processing of volumetric data related to the first output material, by using the acquired generation information and arrangement information of the figure serving as the first output material.

The overview of the volumetric data selection processing is processing of selecting volumetric data corresponding to an arrangement interval, among pieces of volumetric data that correspond to the same scene as a 3D model corresponding to the figure serving as the first output material, and of indicating a3D model corresponding to a different timecode. The details of the volumetric data selection processing will be described with reference to steps S611 to S616 in FIG. 6 and to FIGS. 7A to 7C.

In step S611, the volumetric data selection unit 502 calculates the number of candidates of the second output material from the arrangement interval 732, the figure width 733, and the figure width 734, which serve as the arrangement information acquired in step S601.

Specifically, the volumetric data selection unit 502 acquires the number of candidates of the second output material that might enter an arrangement interval, based on the arrangement interval/figure width. As an example illustrated in in FIGS. 7A to 7C,/60 ≈ 3 is acquired from the arrangement interval 732 = 200 mm, the figure width 733 = 60 mm, and the figure width 734 = 60 mm. In a case where values of the figure width 733 and the figure width 734 are different, it is sufficient that an average value or the like is used. In the example illustrated in FIGS. 7A to 7C, the number of candidates of the second output material becomes 3.

In step S612, the volumetric data selection unit 502 calculates a timecode interval of formative data of a candidate of the second output material from a timecode included in the generation information and from the number of candidates of the second output material acquired in step S611.

Specifically, the volumetric data selection unit 502 sets a value obtained by dividing a difference between timecodes corresponding to a plurality of figures included in a captured image by the number of candidates of the second output material + 1, as a timecode interval for identifying formative data of a candidate of the second output material.

In the example illustrated in FIG. 7A, timecodes of the FIGS. 401 and 402 are 19:01:28.000 and 19:01:30.012, and a difference is 132 frames. If the difference is divided by the number of candidates of the second output material + 1 = 4, a timecode interval becomes 132/4 = 33 frames. In a case where the difference cannot evenly be divided, it is sufficient to round down the value.

The volumetric data selection unit 502 repeats the subsequent processing in steps S613 to S616 the number of times corresponding to the number of candidates of the second output material that has been acquired in step S611. For the sake of convenience, "i" is used as a value to be incremented in loop processing.

In step S614, the volumetric data selection unit 502 determines a timecode of formative data of a candidate of the second output material based on the timecode interval acquired in step S612.

Out of the timecodes of the FIGS. 401 and 402 in FIG. 7A, an earlier timecode is 19:01:28.000 of the FIG. 401. A value obtained by adding the timecode interval multiplied by the number of loops to the timecode of the FIG. 401 becomes a timecode of each piece of formative data of a second output material candidate. In the example illustrated in FIG. 7A, the number of candidates of the second output material equals 3, and a timecode of each piece of formative data of a second output material candidate becomes as follows:
i = first candidate:
19:01:28.000 + 1 * 0.033 = 19:01:28.033;
i = second candidate:
19:01:28.000 + 2 * 0.033 = 19:01:29.006; and
i = third candidate:
19:01:28.000 + 3 * 0.033 = 19:01:29.039.

In step S615, the volumetric data selection unit 502 acquires volumetric data corresponding to the timecode determined in step S614 from the online database 106. Specifically, the volumetric data selection unit 502 acquires volumetric data corresponding to the timecode determined in step S614 from a table designated based on a volumetric table ID included in generation information. The volumetric data selection unit 502 then outputs the acquired volumetric data to the formative data generation unit 503.

Through the above-described processing, it is possible to acquire volumetric data that is to be a candidate of the second output material, among pieces of volumetric data that correspond to the same scene as a 3D model corresponding to the figure, which is the first output material, and represent a 3D model corresponding to a different timecode. The volumetric data needs not be always acquired, and only a3D model included in volumetric data selected from the online database 106 may also be acquired. Also, a 3D model and a bounding box may be acquired. The data to be acquired is only required to be acquired in accordance with data to be used when a composite image is generated or with data to be used for generation of formative data.

In step S604, the formative data generation unit 503 generates formative data based on the volumetric data acquired in step S615, by using various settings included in the generation information corresponding to a figure, which is the first output material that has been acquired in step S602. The generation information to be used at the time of formative data generation mainly includes a magnification ratio, a generation size, a support structure, and a color setting.

Regarding the magnification ratio, scaling processing is performed on a 3D model included in volumetric data in accordance with a setting value (1/24, etc.). It is thereby possible to generate formative data of a second output material candidate at about the same scale size as the foreground portion (player portion) 411, such as a player in the already arranged FIG. 401, which is the first output material, for example.

The generation size is a final generation size of data to which a support structure is added that is obtainable after the above-described magnification ratio setting has been performed, and referring to the value, it is possible to add a support structure to formative data of the second output material in accordance with a generation size of the figure, which is the first output material. The generation size is designated by a three-dimensional coordinate as illustrated in FIGS. 2A to 2F, and referring to the length of at least one side in the generation size of the first output material, the one side may be applied to the generation size of the second output material. For example, in a case where main bodies are covered with transparent material serving as a support structure, their heights may be made uniform.

The color setting is an item for setting color information to be used when a figure is generated. For example, color information included in volumetric data may be applied as-is. In such a case, information representing default is set in the item of the color setting. In addition, regarding color information included in volumetric data, conversion processing may be performed on the volumetric data by using a 3D LUT. In such a case, information regarding the 3D LUT used in the conversion processing is set in the item of the color setting. For example, in a case where the figure serving as the first output material is a figure assumed to be arranged in a special environment, such as a seat illuminated with blue light, conversion processing of color information adapted to the arrangement environment is sometimes performed on the figure serving as the first output material. In such a case, by generating formative data for generating a figure serving as the second output material, in accordance with a color setting included in generation information of the first output material, it is possible to generate a figure adapted to the same arrangement environment.

In formative data processing, as conversion processing other than the above-described processing, in a case where a 3D model has a mesh shape, watertightness and normal inverting error checks are performed, and processing of correcting these may be executed. Because these types of processing are known, the description will be omitted. Unless all errors are solved when data is output to the external print service 107, output generally becomes inexecutable.

The formative data generation unit 503 performs the above-described processing and generates formative data for generating the second output material from volumetric data. In addition, the formative data generation unit 503 generates a virtual viewpoint image by using the generated formative data, and displays the virtual viewpoint image adjacent to the first output material.

A display example on the display unit 517 of the image processing apparatus 500 that is to be displayed at this time will be described with reference to FIG. 7B. In FIG. 7B, formative data pieces 702 to 704 serving as second output material candidates are AR-displayed as virtual viewpoint images adjacent to the FIGS. 401 and 402 serving as the first output material.

The formative data pieces 702 to 704 serving as the second output material candidates respectively include player portions 712 to 714 of foreground data and include transparent material portions 722 to 724 as a support structure.

Through the above-described formative data generation processing, the formative data pieces 702 to 704 serving as the second output material candidates are displayed at positions at an equal interval to the arrangement interval 732 between the FIGS. 401 and 402 serving as the first output material. The formative data pieces 702 to 704 serving as the second output material candidates need not be always displayed at an equal interval, and are only required to be adjacently displayed. For example, in a case where an object, such as a cup, exists at a position with an equal interval, the formative data pieces 702 to 704 may be displayed in such a manner as to avoid the object.

In addition, by generating formative data serving as the second output material by using generation information acquired from the FIGS. 401 and 402 serving as the first output material, it is possible to display a second output material candidate with the same finished style as the first output material as for a scale, a size, a color setting, a support structure, and the like.

In addition, in FIG. 7B, in accordance with the formative data pieces 702 to 704 serving as the second output material, price and output instruction buttons (purchase instruction buttons) 742 to 744 are displayed.

Through the above-described processing, the user can check if there is a major difference or any problem in a scale size, a generation size, color tone, a support structure, and the like, and the user can promptly select a figure desired to be purchased.

In step S605, the formative data generation unit 503 detects whether at least either of the FIGS. 401 and 402 has been moved or changed. This is because, in a case where a figure is moved or changed, a generation width between figures and generation information to be acquired are changed. In a case where a figure movement or change is detected (YES in step S605), the processing returns to step S601, and the above-described processing is executed. In a case where a figure movement or change is not detected (NO in step S605), the processing proceeds to step S606. In the present embodiment, it is assumed to detect a movement in a physical position of the figure in a real space, but the detection is not limited thereto, and a change in a position in a captured image may be detected.

In step S606, the formative data generation unit 503 determines whether a generation target selection instruction has been received from the user on a display screen illustrated in FIG. 7B. In a case where a selection instruction has been received (YES in step S606), the processing proceeds to step S607. In the example illustrated in FIG. 7B, an output instruction button 743 corresponding to the formative data 703 is selected. In a case where a selection instruction has not been received (NO in step S606), the processing returns to step S606, and it is sufficient that the display in FIG. 7B is continued.

In step S607, the formative data generation unit 503 displays a setting confirmation screen of formative data of which a selection instruction has been received up to the previous step. FIG. 7C illustrates a formative data setting confirmation screen.

The formative data setting confirmation screen illustrated in FIG. 7C includes an image 750 of formative data selected in the previous step, generation information 751 of the formative data, a cancel button 752, a setting change button 753, and an output determination button 754. Each item will be described.

The image 750 of the formative data is an image of formative data selected in the previous step. In the example illustrated in FIG. 7C, an image of the formative data 703 is displayed.

The generation information 751 includes values of the same items as the generation information described with reference to FIGS. 4B and 4D, and the generation information 751 is information regarding the selected formative data serving as the second output material.

When the cancel button 752 is pressed, a setting change is cancelled.

When the output determination button 754 is pressed, output is determined.

When the setting change button 753 is pressed, the screen transitions to a setting change screen illustrated in FIG. 8A to make a setting change of the selected formative data.

As described above, in the present embodiment, it is possible to newly generate a figure with the same finished style as the generated FIGS. 401 and 402 by performing formative data generation processing based on generation information. On the other hand, the displayed formative data 703 might be different from formative data desired by the user. For example, a case can be considered where the user desires a figure with a size larger than the FIGS. 401 or 402, or a case where a pose of foreground data 713 included in the formative data 703 is desired to be changed. The setting change screen illustrated in FIG. 8A is displayed in a case where formative data is desired to be edited, as described above. The setting change screen will also be referred to as an edit screen.

As illustrated in FIG. 7C, on the setting confirmation screen, AR display executed up to the previous step may be ended, and a normal 2D screen may be displayed. On the setting confirmation screen, AR display of the above-described captured display screen 710 may be continued, and a region other than the formative data selected in the previous step may be displayed in a blurred state (not illustrated).

FIG. 8A illustrates a formative data setting change screen to be displayed when the setting change button 753 is pressed. As illustrated in FIG. 8A, a timecode 851, a magnification ratio 852, a generation size 853, a support structure 854, a color setting 855, and a timecode change bar 856 are displayed. In addition, the FIGS. 401 and 402 serving as the first output material, and the formative data pieces 702 to 704 serving as second output material candidates, are displayed on the formative data setting change screen, as items for receiving a setting change.

A price 857, a cancel button 861, and an output determination button 862 are also displayed. Each setting item will be described.

In the timecode 851, a timecode can be changed by using the timecode change bar 856. A value may be changed by directly editing a numerical value.

In the magnification ratio 852, a magnification ratio of formative data can be changed. An arbitrary value can be input.

In the generation size 853, a generation size can be changed. In a case where a size of volumetric data changes due to a change in the timecode 851, the generation size 853 is automatically updated.

In the support structure 854, the type of support structure can be changed.

In the color setting 855, a color setting in formative data generation can be changed. For example, a3D LUT to be used can be changed.

In the price 857, a price is determined in accordance with a size of which a setting is being changed. When a price is to be determined, the external print service 107 may be inquired of, and an inquiry result may be displayed.

In step S607, the setting change button 753 is pressed, and default values of items to be displayed on the setting change screen are set based on the generation information acquired in step S602, and the selected formative data serving as a second output material candidate. Specifically, a default value of the timecode 851 is set to a value corresponding to the selected formative data serving as a second output material candidate. As for other items, values included in the generation information acquired in step S602 are used as default values.

In a case where any of the above-described values is changed, in the formative data generation processing illustrated in FIG. 6, the processing proceeds to step S608. Alternatively, in a case where the cancel button 861 is pressed, the processing returns to step S606.

In step S608, the formative data generation unit 503 re-generates formative data based on a setting value changed in the previous step and updates the display unit 517. As an example, a case where a timecode is changed will be described.

In a case where a timecode change instruction is received using the timecode change bar 856, the formative data generation unit 503 acquires, via the volumetric data selection unit 502, volumetric data corresponding to the changed timecode, from the online database 106.

Specifically, a table identified based on a volumetric data table ID included in the generation information acquired in step S602 is designated, and volumetric data corresponding to the changed timecode is acquired. Then, formative data is re-generated by a procedure illustrated in step S604, and the display screen is updated.

FIG. 8B illustrates a case where the timecode 851 is changed by operating the timecode change bar 856 in FIG. 8A. In FIG. 8B, a value of the timecode is changed from "19:01:29.006" in FIG. 8A to "19:06:29.000". Accordingly, the formative data 703 is updated to formative data 803. The formative data 803 is data indicating a state of six frames earlier than the state of the formative data 703, and the data has been changed to a data indicating a state before a ball impact in a swing of a baseball bat.

In the example illustrated in FIG. 8B, a generation size is also changed in accordance with a change in volumetric data. In FIG. 8B, a generation size is changed from "60 mm * 60 mm * 100 mm" to "100 mm * 60 mm * 100 mm".

When the size is changed as described above, an arrangement interval is also updated, and in a case where the arrangement interval becomes shorter than the original distance, the formative data pieces 702 and 704, which are the other candidates, may be deleted from the display screen.

As illustrated in FIG. 8B, the price 857 is updated in accordance with the size by changing the size.

In a case where the generation size 853, the support structure 854, and the color setting 855, which are other setting items, are changed, volumetric data is not reacquired, unlike the case where the timecode 851 is changed. It is sufficient that, as for volumetric data to be held, formative data is re-generated and screen display is updated based on a change.

Although not illustrated, for a 3D printer model and a print service illustrated in the generation information in FIGS. 4A to 4E, setting change items in FIGS. 8A and 8B may also be displayed, and a setting change may be received from the user.

In step S609, the formative data generation unit 503 transmits formative data determined up to the previous step to the external print service 107.

Through the above-described processing, in a scene in which a figure serving as the first output material generated from volumetric data is arranged for ornamental purposes, it is possible to generate formative data serving as a second output material candidate chronologically related to the figure from the aspect of timecode. By displaying the formative data as a virtual viewpoint image adjacent to the figure serving as the first output material, the user can then intuitively select a desired frame and output the formative data to an external print service or the like.

Format conversion adapted to the external print service 107 may also be executed on the formative data. Regarding the formative data, a problem will not occur in the output to a normal external print service 107 as long as the 3D model has a general-purpose format.

Aside from the external print service 107, connection to a payment agency website (not illustrated) or the like may also be established, and payment related to the output of the formative data may be made.

When arrangement information is acquired in step S601, in a case where there are three or more figures that are not arranged chronologically, an error indicating such may be displayed. In the acquired arrangement information, in a case where an arrangement interval does not have an enough distance for a figure width, an error indicating such may be displayed.

When generation information is acquired in step S602, in a case where a different volumetric table ID is designated in the generation information acquired from the FIGS. 401 and 402, an error indicating such may be displayed. In the acquired generation information, in a case where a timecode interval has a predetermined value or more, an error indicating such may be displayed.

By using the present embodiment, it becomes possible for the user to make a setting change on formative data serving as a second output material candidate that has been generated based on generation information added to the first output material. Because formative data is re-generated and display is updated each time a setting change is made, the user can also check a setting change as needed.

In the present embodiment, a mock-up is generated using a 3D model generated using the volumetric capture, but a generation method is not limited thereto. For example, a 3D model may also be generated using photogrammetry. A 3D model may also be a 3D model generated using computer graphics (CG).

### Second Embodiment

In the second embodiment, formative data generation processing and a display screen of the image processing apparatus 500 that is to be displayed in the processing in a case where the number of generated figures is only one will be described. In the present embodiment, the virtual viewpoint image generation system (FIGS. 1A to 1C), the image processing apparatus 500 (FIGS. 4A to 4E), and the formative data generation processing (FIG. 6) that are the same as those in the first embodiment are used, and thus description of the same points as the first embodiment will be omitted.

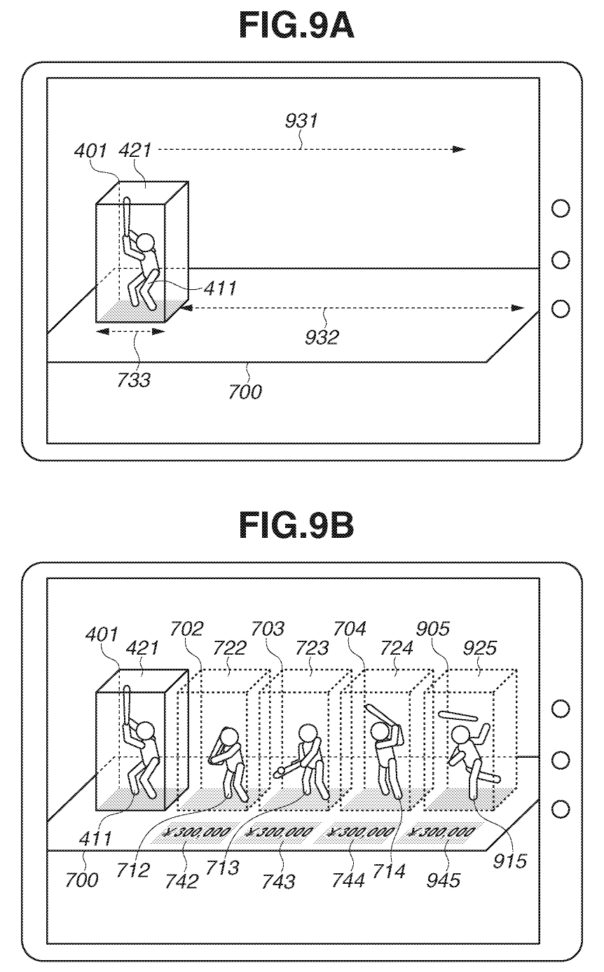

FIGS. 9A and 9B illustrate formative data generation processing to be executed in a case where only one figure serving as a first output material is arranged will be described.

FIG. 9A illustrates a state in which a FIG. 401 serving as a first output material on a desk 700, which is an arrangement environment, is displayed on the display unit 517 of the image processing apparatus 500. For the sake of simplification of explanation, the FIG. 401 serving as the first output material is the same figure as that illustrated in FIGS. 4A, 4B,or 7A to 7C in the first embodiment.

In the example illustrated in FIG. 9A, an arrangement direction 931, a figure width 733, an arrangement interval 932, and the like are acquired as arrangement information.

The arrangement direction 931 is determined depending on an arrangement direction of the one figure or on a direction of the desk 700 serving as an arrangement environment. The arrangement direction 931 may be determined corresponding to the orientation of the FIG. 401. The orientation of the FIG. 401 is determined in advance and is included in generation information corresponding to the FIG. 401. In such a case, the orientation of the FIG. 401 is set as an arrangement direction. The direction of the arrangement direction 931 may be designated by a touch operation or the like on the operation input unit 516 or the display unit 517 (not illustrated).

The arrangement interval 932 is acquired based on a distance to the end of the desk 700 serving as an arrangement environment.

In the present embodiment, the arrangement interval 932 = 280 mm and the figure width 733 = 60 mm are acquired as an example.

The direction of the arrangement direction 931 and values of the arrangement interval 932 and the figure width 733 may be displayed on a display screen of an image display generation apparatus.

Regarding the arrangement interval 932, range designation may be received by a touch operation or the like on the operation input unit 516 or the display unit 517 (not illustrated).

Even in a case where only one figure is provided as the FIGS. 401 and 402 serving as the first output material, as described above, if arrangement information is acquired in step S601, the processing in steps S602 to S609 can be executed similarly to the first embodiment.

Subsequently, a difference in the volumetric data selection processing (steps S611 to S616) will mainly be described.

In step S611, the formative data generation unit 503 calculates the number of arranged second output materials from the arrangement interval 932 and the figure width 733, which serve as arrangement information of the FIGS. 401 and 402 that has been acquired up to the previous step.

Specifically, the formative data generation unit 503 acquires the number of candidates of the second output material that might enter the arrangement interval 932, by calculating the arrangement interval 932 divided by the figure width 733. As an example, using the arrangement interval 932 = 280 mm and the figure width 733 = 60 mm, 280/60 ≈ 4 is acquired.

In step S612, the formative data generation unit 503 calculates a timecode interval of formative data serving as second output material candidates by using a timecode included in generation information and using the number of candidates of the second output material that has been acquired in the previous step.

In the present embodiment, unlike the first embodiment, one single first output material is provided. Thus, a timecode of either start or end of a corresponding scene cannot be acquired from the generation information. For this reason, generation information as well as an arrangement interval included in arrangement information may also be used. For example, in a case where the arrangement interval 932 is provided on the right side of the first output material (FIG. 401) when viewed from the image processing apparatus 500, a time progression direction is often regarded as a direction from left to right when viewed from the front. Thus, a timecode of a scene end is searched for.

In contrast, in a case where the arrangement interval 932 is provided on the left side of the first output material (FIG. 401), a timecode of a scene start is searched for.

Subsequently, to search for a timecode of scene start or end, the online database 106 is searched for a peripheral timecode based on a timecode obtained from generation information of the first output material. At this time, a bounding box of the first output material is used. The bounding box has been described with reference to FIG. 2C. For example, the bounding box of the first output material and a bounding box of the peripheral timecode are compared in order, and a point where a change of a predetermined value or more occurs may be regarded as the start or end of the same scene.

For example, in the example illustrated in FIG. 9A, the arrangement interval 932 is provided on the right side of the FIG. 401 serving as the first output material, and thus it is sufficient that a timecode of the end of the same scene is searched for. Since the same scene is a scene of a swing as described with reference to FIGS. 4A to 4E, at a time point at which a batter exits from a batter's box toward the first base after the batter hits a ball, it may be determined that a value of the bounding box becomes a predetermined value or more, and its timecode may be regarded as an end. Here, it is assumed that a timecode "19:01:30.012" of volumetric data illustrated in FIG. 2F is searched for. Because the timecode of the first output material is "19:01:28.000" as included in the generation information, it becomes possible to calculate the timecode interval for step S612.

Although not illustrated, in a case where the arrangement interval 932 is provided on the left side of the FIG. 401 serving as the first output material, a timecode of a scene start can also be searched for by a similar method.

Although not illustrated, in a case where the FIG. 401 serving as the first output material is arranged near the center of the desk 700 serving as an arrangement environment, timecodes of scene start and end may also be searched for by applying a similar method to both arrangement intervals on the left and right.

In step S612, the formative data generation unit 503 calculates a value obtained by dividing a difference between start and end timecodes of the scene by the number of candidates of the second output material, as a timecode interval of formative data serving as second output material candidate.

In the example illustrated in FIG. 9A, the start and end timecodes of the scene are 19:01:28.000 and 19:01:30.012, and a difference is 132 frames. When the difference is divided by the number of candidates of the second output material = 4, a timecode interval becomes 132/4 = 33 frames. In a case where the difference cannot evenly be divided, it is sufficient to round down the value.

The formative data generation unit 503 repeats the processing in steps S613 to S616 the number of times corresponding to the number of candidates of the second output material that has been acquired up to the previous step. For the sake of convenience, "i" is used as a value to be incremented in loop processing.

In step S614, the formative data generation unit 503 determines a timecode of formative data of a second output material candidate based on the timecode interval acquired up to the previous step.

In the example illustrated in FIG. 9A, a value obtained by adding the timecode interval multiplied by the number of loops to the timecode 19:01:28.000 of the scene start of the FIG. 401 serving as the first output material becomes a timecode of each piece of formative data of a second output material candidate. In the example illustrated in FIG. 9A, because the number of candidates of the second output material equals 4, a timecode of each piece of formative data becomes as follows:
i = first candidate:
19:01:28.000 + 1 * 0.033 = 19:01:28.033;
i = second candidate:
19:01:28.000 + 2 * 0.033 = 19:01:29.006;
i = third candidate:
19:01:28.000 + 3 * 0.033 = 19:01:29.039; and
i = fourth candidate:
19:01:28.000 + 4 * 0.033 = 19:01:30.012.

In step S615, the formative data generation unit 503 acquires volumetric data corresponding to the timecode determined up to the previous step, from a table designated based on a volumetric table ID included in generation information that is stored in the online database 106.

In step S604, the formative data generation unit 503 generates formative data based on the volumetric data acquired up to the previous step, using various settings included in the generation information acquired in step S602. The generation information to be used at the time of formative data generation mainly includes a magnification ratio, a color setting, and support structure addition, and such a usage method is similar to that in the first embodiment. The formative data generation unit 503 generates a virtual viewpoint image from the generated formative data and generates a composite image in which the virtual viewpoint image is displayed adjacent to the first output material. The generated composite image is also displayed on the display unit 517. FIG. 9B illustrates a display example on the display unit 517 of the image processing apparatus 500 that is to be displayed at this time.

In FIG. 9B, formative data pieces 702 to 704 and 905 serving as second output material candidates are AR-displayed, as virtual viewpoint images, adjacent to FIG. 401 serving as the first output material.

The formative data pieces 702 to 704 and 905 serving as second output material candidates include foreground data pieces 712 to 714 and 915 and include transparent material portions 722 to 724 and 925 serving as a support structure.

In addition, generating formative data serving as the second output material by using generation information acquired from the FIG. 401 serving as the first output material makes it possible to display a second output material candidate having the same finished style as the first output material as for a scale size, a size, a color setting, a support structure, and the like.

Through the above-described processing, it becomes possible to generate, from one figure, formative data of a 3D model related to a 3D model related to the figure. The user can accordingly easily generate formative data for generating a desired figure.

### Third Embodiment

In the first embodiment, the system that easily generates formative data for generating a new figure, by capturing an image of a figure with a user device such as a smartphone and using a 3D model used to generate the figure, has been described. In the present embodiment, a system will be described that easily generates formative data for generating an acrylic stand, by using a 3D model used to generate a figure. The description of the same processing as that in the first embodiment will be omitted.

In the present embodiment, an item of the type of a mock-up is added to formative data. For this reason, on a formative data setting change screen, an item for setting the type of a mock-up is displayed. The user can change the type to the type of a desired mock-up by editing the item of the type of the mock-up. A default value of the type of the mock-up is determined based on information included in generation information acquired in step S602. For example, in a case where generation information is acquired by capturing an image of a figure, figure is set as a default value of the type of the mock-up. In the present embodiment, an example will be described of changing the type of a mock-up, which is included in generation information acquired by capturing an image of a figure, to acrylic stand, but the type is not limited thereto. The type of the mock-up is figure, acrylic stand, keyholder, or the like. The type of a mock-up that is to be set is included in generation information and formative data as type information.

Regarding the support structure included in formative data, a settable item is changed in accordance with the type of the mock-up. For example, in a case where the type of the mock-up is acrylic stand, the presence or absence of a coupling member for coupling with a seat can be selected as a support structure. For example, in a case where the type of the mock-up is keyholder, chain shape and material can be selected.

The support structure as well as an additional setting suitable for the type of the mock-up may also be included. For example, in a case where the type of the mock-up is acrylic stand, an acrylic stand edged to cut out a foreground may be generated, or an acrylic stand including a desired background may also be generated without performing edging. In addition, an acrylic stand surrounded by a transparent member may also be generated without including the background. The presence or absence of edging may also be made settable as an additional setting. In a case where the type of the mock-up is acrylic stand, an acrylic stand includes a virtual viewpoint image showing a 3D model. Thus, as an additional setting, items of the position and the orientation of a virtual camera for changing the position and the orientation of the virtual camera for generating a virtual viewpoint image may be provided. For example, among a plurality of virtual cameras arranged in such a manner as to surround a 3D model, a virtual viewpoint image may be made selectable using information regarding the position and the orientation of any virtual camera. Also, by providing a slide bar (not illustrated), and operating the slide bar, a virtual camera may be moved to the circumference of a circle centered on a 3D model, and the virtual camera may be controlled to always face the 3D model.

With the above-described configuration, it becomes possible to easily generate a mock-up desired by the user. In the present embodiment, generating formative data for generating an acrylic stand, from generation information acquired by capturing an image of a figure, has been described, but a generation method is not limited thereto. For example, formative data for generating a figure may also be generated from generation information acquired by capturing an image of an acrylic stand. Also, formative data for generating a keyholder may also be generated from generation information acquired by capturing an image of a figure.

According to the present disclosure, it is possible to easily determine a 3D model to be used when a mock-up is generated.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-016869, which was filed on February 4, 2025 and which is hereby incorporated by reference herein in its entirety.

What is claimed is:

1. An information processing apparatus comprising:
one or more memories storing instructions; and
one or more processors executing the instructions to:
acquire, based on a mock-up, first information for identifying a three-dimensional (3D) model corresponding to the mock-up, and
perform control of displaying an edit screen on which second information for generating a mock-up based on the 3D model is editable.

2. The information processing apparatus according to claim 1, wherein the first information is acquired based on a captured image including the mock-up.

3. The information processing apparatus according to claim 1, wherein the first information is acquired based on communication with a communication unit associated with the mock-up.

4. The information processing apparatus according to claim 1, wherein the first information is an identifier of a subject corresponding to the 3D model.

5. The information processing apparatus according to claim 1, wherein the second information is information for generating a mock-up of a 3D model of a same subject as a subject corresponding to the 3D model.

6. The information processing apparatus according to claim 1, wherein the second information is time information corresponding to a 3D model to be used to generate a mock-up.

7. The information processing apparatus according to claim 1, wherein the second information is color information corresponding to a 3D model to be used to generate a mock-up.

8. The information processing apparatus according to claim 1, wherein the second information is information representing a size of a mock-up.

9. The information processing apparatus according to claim 1, wherein the second information is type information indicating a type of a mock-up.

10. The information processing apparatus according to claim 9, wherein the type of the mock-up is any of figure, acrylic stand, and keyholder.

11. The information processing apparatus according to claim 10, wherein, in a case where the type of the mock-up is acrylic stand, the second information includes information for identifying an orientation of a 3D model included in a virtual viewpoint image to be used for generation of an acrylic stand.

12. The information processing apparatus according to claim 11, wherein the second information includes information representing a position and an orientation of a virtual camera corresponding to the virtual viewpoint image.

13. The information processing apparatus according to claim 10, wherein, in a case where the type of the mock-up is keyholder, the second information includes information representing a shape of a coupling portion of a keyholder.

14. The information processing apparatus according to claim 1, wherein the second information is acquired.

15. The information processing apparatus according to claim 1, wherein the edit screen is generated.

16. The information processing apparatus according to claim 1, wherein the 3D model is generated based on a plurality of captured images.

17. An image processing system comprising:
one or more memories storing instructions; and
one or more processors executing the instructions to:
acquire, based on a mock-up, first information for identifying a three-dimensional (3D) model corresponding to the mock-up,
acquire the 3D model based on the first information,
generate an edit screen on which second information for generating a mock-up based on the 3D model is editable, and
perform control of displaying the edit screen.

18. An information processing method comprising:
acquiring, based on a mock-up, first information for identifying a three-dimensional (3D) model corresponding to the mock-up; and
performing control of displaying an edit screen on which second information for generating a mock-up based on the 3D model is editable.

19. An image processing method comprising:
acquiring, based on a mock-up, first information for identifying a three-dimensional (3D) model corresponding to the mock-up;
acquiring the 3D model based on the first information;
generating an edit screen on which second information for generating a mock-up based on the 3D model is editable; and
performing control of displaying the edit screen.

20. A non-transitory computer-readable storage medium storing computer-executable instructions for causing a computer to execute the information processing method according to claim 18.
